(19) United States
(12) Patent Application Publication
(10) Pub. No.: US 2021/0398443 A9
(43) Pub. Date: Dec. 23, 2021

(54) Technology-Facilitated Support System for Monitoring and Understanding Interpersonal Relationships

(71) Applicant: UNIVERSITY OF SOUTHERN CALIFORNIA, Los Angeles, CA (US)

(72) Inventors: SHRIKANTH SAMBASIVAN NARAYANAN, SANTA MONICA, CA (US); GAYLA MARGOLIN, LOS ANGELES, CA (US); ADELA C. AHLE, SAN FRANCISCO, CA (US); THEODORA CHASPARI, COLLEGE STATION, TX (US)

(21) Appl. No.: 16/501,103

(22) Filed: Mar. 2, 2018

Related U.S. Application Data
(60) Provisional application No. 62/561,938, filed on Sep. 22, 2017.

(51) Int. Cl. G09B 19/00; G10L 15/22; G10L 25/63

(52) U.S. Cl. CPC G09B 19/00; G10L 25/63; G10L 15/22

(57) ABSTRACT

A method for monitoring and understanding interpersonal relationships includes a step of monitoring interpersonal relations of a couple or group of interpersonally collected users with a plurality of smart devices by collecting data streams from the smart devices. Representations of interpersonal relationships are formed for increasing knowledge about relationship functioning and detecting interpersonally-relevant mood states and events. Feedback and/or goals are provided to one or more users to increase awareness about relationship functioning.

### STATEMENT REGARDING FEDERALLY SPONSORED RESEARCH OR DEVELOPMENT

The invention was made with Government support under Contract No. R21 HD072170-A1 awarded by the National Institutes of Health/National Institute of Child Health and Human Development; Contract Nos. BCS-1627272, DGE-0937362, and CCF-1029373 awarded by the National Science Foundation; and Contract No. UL1TR000130 awarded by the National Institutes of Health. The Government has certain rights to the invention.

### TECHNICAL FIELD

In at least one embodiment, the present invention is related to automated frameworks for monitoring, quantifying, and modeling interpersonal relationships. In particular, the present invention is related to applications of such frameworks that include the development of novel, individualized measures of relationship functioning and the development of data-driven, automated feedback systems.

### BACKGROUND

The quality of interpersonal relationships is closely tied to both mental well-being and physical health. Frequent conflict in relationships can cause elevated and chronic levels of stress responding, leading to increased risk of cardiac disease, cancer, anxiety, depression, and early death; in contrast, supportive relationships can buffer stress responding and protect health (Burman & Margolin, 1992; Coan, Schaefer, & Davidson, 2006; Grewen, Andersen, Girdler, & Light, 2003; Holt-Lunstad, Smith, & Layton, 2010; Leach, Butterworth, Olesen, & Mackinnon, 2013; Robles & Kiecolt Glaser, 2003). Epidemiological research has shown that the health risks of social isolation are comparable to other well-known risk factors, such as smoking and lack of exercise (House, Landis, & Umberson, 1988). Other research shows that family relationships, including the way parents interact with their children, have a large impact on child functioning across the lifespan, contributing to the development of psychological problems, as well as poor health outcomes in adulthood (Springer, Sheridan, Kuo, & Carnes, 2007). More broadly, research suggests that other types of interpersonal stressors, such as conflicts with coworkers, are highly stressful, impact our physical and mental health, and contribute to missed workdays and decreased well-being (Sonnentag, Unger, & Nagel, 2013). The toll of negative relationships on physical and mental health, taken in combination with lost productivity at work, results in billions of dollars of lost revenue annually (Lawler, 2010; Sacker, 2013).

To date, attempts to detect psychological, emotional, or interpersonal states via machine learning and related technologies have largely been done in controlled laboratory settings, for example identifying emotional states during lab-based discussion tasks (e.g., Kim, Valente, & Vinciarelli, 2012; Hung, & Englebienne, 2013). Other research has attempted to automatically detect events of interest in uncontrolled settings as people live out their daily lives; however, these attempts have focused on detecting discrete and more easily identifiable states, e.g., whether people are exercising versus not exercising, and have pertained to individuals rather than systems of people (Lee et al., 2013). Detecting complex emotional and interpersonal states, e.g., feeling close to someone or having conflict, in real life settings is difficult because there is substantially more variability in the data, where various confounding factors, e.g., background speech, could influence signals and decrease the accuracy of the identification systems.

### SUMMARY

The present invention solves one or more problems of the prior art by providing in at least one embodiment, a method and system for improving the quality of relationship functioning. The system is advantageously compatible with various technologies—including but not limited to smartphones, Titbits, smartwatches, other wearables, and smart home devices—that makes use of multimodal data to provide detailed feedback and monitoring and to improve relationship functioning, with potential downstream effects on individual mental and physical health. Using pattern recognition, machine learning algorithms, and other technologies, this system detects relationship-relevant events and states (e.g., feeling stressed, criticizing your partner, having conflict, having physical contact, having positive interactions, providing support) and provides tracking, monitoring, and status reports. This system applies to a variety of relationship types, such as couples, friends, families, workplace relationships, and can be employed by individuals or implemented on a broad scale by institutions and large interpersonal networks, for example in hospital or military settings.

In the context of the present invention, a proof-of-concept study was recently published in IEEE Computer. In this study, multimodal data generated from smartphone and wearable devices was used to detect when couples were having conflict with each other with 86% accuracy (Timmons, et al., 2017); the entire disclosure of this publication is hereby incorporated by reference. This study received attention in the media and was covered in articles by various news outlets, including CNET, TechCrunch, NBC, Digital Trends, IEEE Spectrum, and the Daily Mail (see News Coverage section).

### BRIEF DESCRIPTION OF THE DRAWINGS

FIG. 1A is a schematic of a framework implementing embodiments of the invention.

FIG. 1B is a front view of a smart device used in the system of FIG. 1.

FIG. 2 is a schematic of a smart device used in the system of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In an embodiment, a method of monitoring and understanding interpersonal relationships is provided. The method includes a step of monitoring interpersonal relations for a couple or a group of interpersonally collected users with a plurality of smart devices by collecting data streams from the smart devices. Representations of interpersonal relationships are formed for increasing knowledge about relationship functioning and detecting interpersonally-relevant mood states and events. Feedback and/or goals are provided to one or more users to increase awareness about relationship functioning.

In a variation, the representations of interpersonal relationships can be signal-derived and/or machine-learning based representations. In a refinement, the data streams include one or more components selected from the group consisting of physiological signals; audio measures; speech content; video; GPS; light exposure; content consumed and exchanged through mobile, internet, network communications; sleep characteristics; interaction measures between individuals and across channels; and self-reported data about relationship quality, negative and positive interactions, and mood. In a refinement, pronoun use, negative emotion words, swearing, certainty words in speech can be evaluated. In another refinement, sleep length or quantity can be quantified. The content of text messages and emails, time spent on the internet, number or length of tests and phone calls in the network communications can also be measured.

The data collected in the variations and refinements set forth above can be stored separately in a peripheral device or integrated into a single platform. Examples of suitable peripheral storage devices include, but are not limited to, a wearable sensor, cell phone, or audio storage device. In another refinement, the single platform can be a mobile device or IoT platform.

In a variation, the method further includes a step of computing signal-derived representations of the data streams. The signal-derived representation can be computed by knowledge-based design and/or data-driven analyses, which can include clustering. In a refinement, the signal-derived representations is used as a foundation for machine learning, data mining, and statistical algorithms that can be used to determine what factors, or combinations of factors, predict a variety or relationship dimensions, such as conflict, relationship quality, or positive interactions. A combination of self-report data, coding of interviews, observations, videos, and/or audio recordings can be compared to the signal-derived representations to determine the accuracy of the systems. Statistics, e.g., regression analyses, latent class analysis can be used to predict changes in relationship functioning.

In another variation, individual models are used to increase classification accuracy since patterns of interaction may be specific to individuals, couples, or groups of individuals. In a refinement, active and semi-supervised learnings are applied to increase predictive power as people continue to use a system implementing the method.

In another variation, the relationship functioning includes indices selected from the group consisting of a ratio of positive to negative interactions, number of conflict episodes, an amount of time two users spent together, an amount of quality time two users spent together, amount of physical contact, exercise, time spent outside, sleep quality and length, and coregulation or linkage across these measures. In a refinement, the method further includes a step of suggesting goals for these indices and allowing users to customize their goals.

In some variations, feedback can be provided as ongoing tallies and/or graphs viewable on the smart device. In a refinement, daily, weekly, and yearly reports of relationship functioning are created. In another refinement, the users can view, track, and monitor each of these data streams and their progress on their goals via customizable dashboards.

In a variation, the method further includes a step of analyzing each data stream to provide a user with covariation of user's mood, relationship functioning, and various relationship-relevant events. The user can also create personalized networks and specify relationship types for each person in their network. The user can also set person-specific privacy settings and customize personal data that can be accessed by others in their networks.

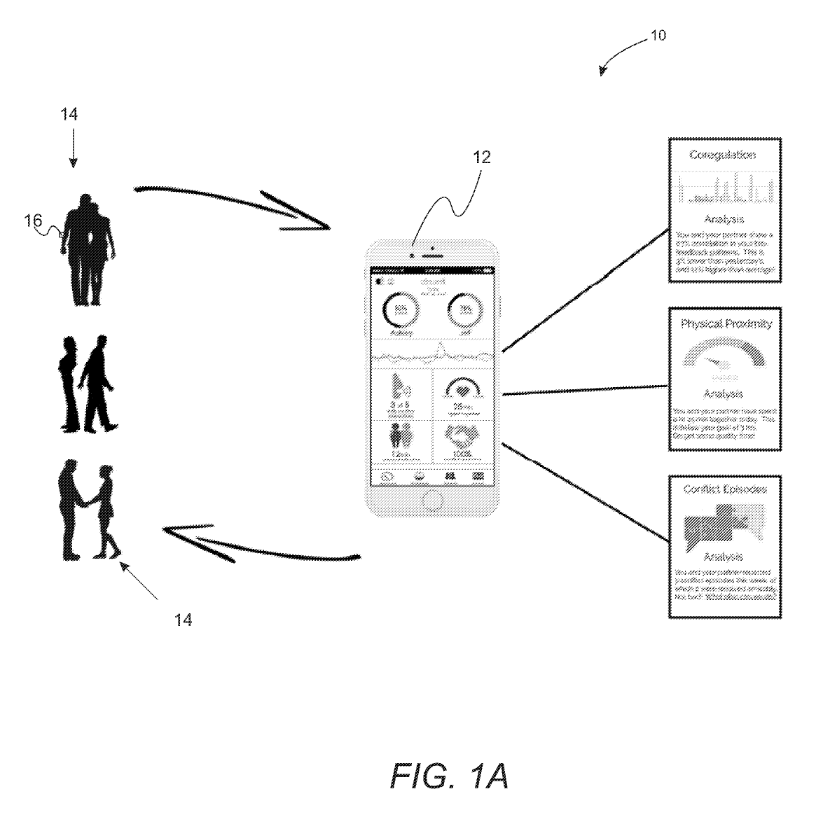

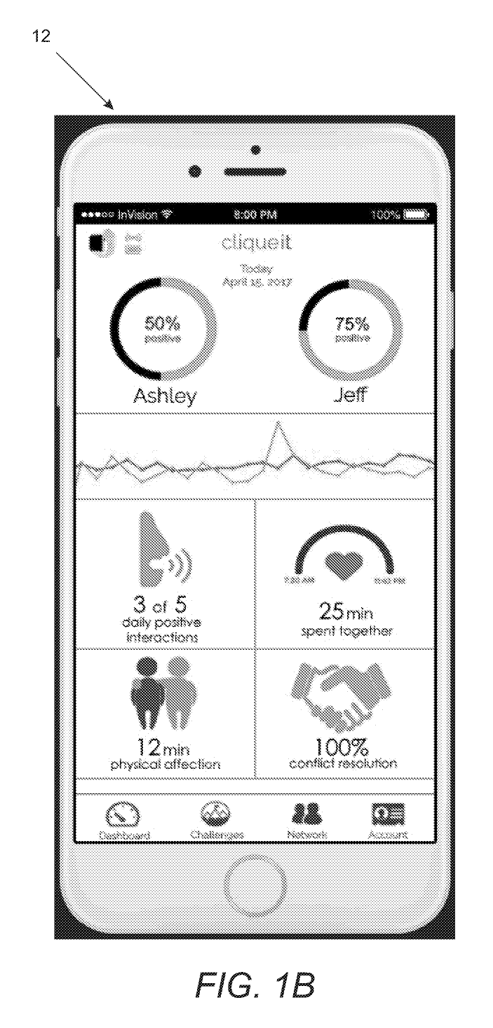

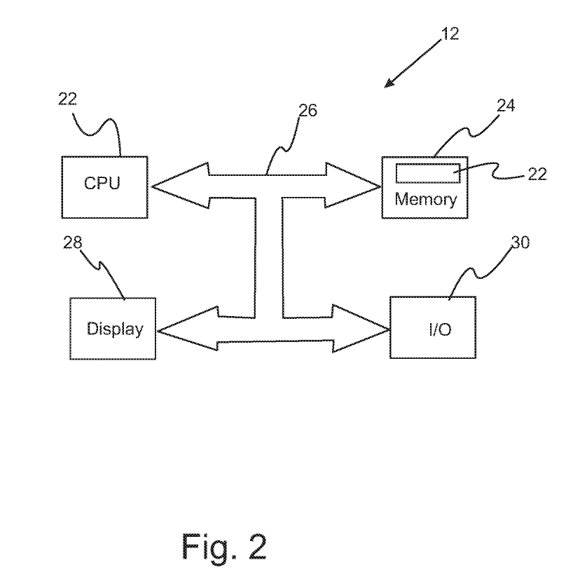

In an embodiment, a system that implements the previously described method of monitoring and understanding interpersonal relationships is provided. With reference to FIGS. 1A, 1B, and 2, system 10 includes a plurality of mobile smart devices 12 operated by a plurality of users 14. In a variation, the system can further include a plurality of sensors 16 (e.g., heart rate sensors, blood pressure sensors, etc.) worn by the plurality of users. The mobile smart devices 12 used this system that implements the abovementioned method can include a microprocessor and a non-volatile memory on which instructions for implementing the method are stored. For example, smart devices 12 can include computer processor 22 that executes one, several, or all of the steps of the method. It should be appreciated that virtually any type of computer processor may be used, including microprocessors, multicore processors, and the like. The steps of the method typically are stored in computer memory 24 and accessed by computer processor 22 via connection system 26. In a variation, connection system 26 includes a data bus. In a refinement, computer memory 24 includes a computer-readable medium which can be any non-transitory (e. g., tangible) medium that participates in providing data that may be read by a computer. Specific examples for computer memory 24 include, but are not limited to, random access memory (RAM), read only memory (ROM), hard drives, optical drives, removable media (e.g. compact disks (CDs), DVD, flash drives, memory cards, etc.), and the like, and combinations thereof. In another refinement, computer processor 22 receives instructions from computer memory 24 and executes these instructions, thereby performing one or more processes, including one or more of the processes described herein. Computer-executable instructions may be compiled or interpreted from computer programs created using a variety of programming languages and/or technologies including, without limitation, and either alone or in combination, Java, C, C++, C#, Fortran, Pascal, Visual Basic, Java Script, Perl, PL/SQL, etc. Display 28 is also in communication with computer processor 22 via connection system 16. Smart device 12 also optionally includes various in/out ports 30 through which data from a pointing device may be accessed by computer processor 22. Examples for the electronic devices include, but are not limited to, desktop computers, smart phones, tablets, or tablet computers.

Additional details of the invention are found in attached Exhibit A.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

Burman, B., & Margolin, G. (1992). Analysis of the association between marital relationships and health problems: An interactional perspective. Psychological Bulletin, 112, 39-63. doi: 10.1037/0033-2909.112.1.39
Coan, J. A., Schaefer, H. S., & Davidson, R. J. (2006). Lending a hand: Social regulation of the neural response to threat. Psychological Science, 17, 1032-1039. doi: 10.1111/j.1467-9280.2006.01832.x
Grewen, K. M., Andersen, B. J., Girdler, S. S., & Light, K. C. (2003). Warm partner contact is related to lower cardiovascular reactivity. Behavioral Medicine, 29, 123-130. doi: 10.1080/08964280309596065
Hung, H., & Englebienne, G. (2013). Systematic evaluation of social behavior modeling with a single accelerometer. Processing of the ACM International Joint Conference on Pervasive and Ubiquitous Computing, 127-139. doi: 10.1145/2494091.2494130
Holt-Lunstad, J., Smith, T. B., & Layton, J. B. (2010). Social relationships and mortality risk: A meta-analytic review. PLoS Medicine, 7, e1000316. doi: 10.1371/journal.pmed.1000316
House, J. S., Landis, K. R., & Umberson, D. (1988). Social relationships and health. Science, 241, 540-545.
Kim, S., Valente, F., & Vinciarelli, A. (2012). Automatic detection of conflict in spoken conversations: Ratings and analysis of broadcast political debates. Proceedings of IEEE International Conference on Acoustic, Speech, and Signal Processing, 5089-5092. doi: 10.1109/ICASSP.2012.6289065
Lawler, J. (2010). The real cost of workplace conflict. Entrepreneur. Accessed from https://www.entrepreneur.com/article/207196.
Leach, L. S., Butterworth, P., Olesen, S. C., & Mackinnon, A. (2013). Relationship quality and levels of depression and anxiety in a large population-based survey. Social Psychiatry and Psychiatric Epidemiology, 48, 417-425. doi: 10.1007/s00127-012-0559-9
Lee, Y., Min, C., Hwang, C., Lee, J., Hwang, I., Ju, Y., . . . Song J. (2013). SocioPhone: Everyday face-to-face interaction monitoring platform using multi-phone sensor fusion. Proceedings of the International Conference on Mobile Systems, Applications, and Services, 375-388. doi: 10.1145/2462456.2465426
Lunbald, A., & Hansson, K. G. (2005). The effectiveness of couple therapy: Pre- and post-assessment of dyadic adjustment and family climate. Journal of Couple & Relationship Therapy, 4, 39-55. doi: 10.1300/J398v04n04_03
Robles, T. F., & Kiecolt-Glaser, J. K. (2003). The physiology of marriage: Pathways to health. Physiology and Behavior, 79, 409-416. doi: 10.1016/50031-9384(03)00160-4
Sacker, A. (2013). Mental health and social relationships. Evidence Briefing of the Economic and Social Research Council. Accessed from http://www.esrc.ac.uk/files/news-events-and-publications/evidence-briefings/mental-health-and-social-relationships/
Sonnentag, S., Unger, D., & Nagel, I. (2013). Workplace conflict and employee well-being: The moderating role of detachment from work during off-job time. International Journal of Conflict Management, 24, 166-183. Doi: 10.1108/10444061311316780
Springer, K. W., Sheridan, J., Kuo, D., & Carnes, M. (2007). Long-term physical and mental health consequences of childhood physical abuse: Results from a large population-based sample of men and women. Child Abuse & Neglect, 31, 517-530. doi: 10.1016/j.chiabu.2007.01.003
Timmons, A. C., Chaspari, T., Han, S. C., Perrone, L., Narayanan, S., & Margolin, G. (2017). Using multimodal wearable technology to detect conflict among couples. IEEE Computer, 50, 50-59. doi:10.1109/MC.2017.83

What is claimed is:

1. A method for monitoring and understanding interpersonal relationships comprising:
monitoring interpersonal relations of a couple or group of interpersonally collected users with a plurality of smart devices by collecting data streams from the smart devices;
forming representations of interpersonal relationships for increasing knowledge about relationship functioning and detecting interpersonally-relevant mood states and events; and
providing feedback and/or goals to one or more users to increase awareness about relationship functioning.

2. The method of claim 1 wherein the representations of interpersonal relationships are signal-derived and machine-learning based representations.

3. The method of claim 1 wherein the data streams include one or more components selected from the group consisting of physiological signals, audio measures, speech content, video, GPS, light exposure, content consumed and exchanged through mobile, internet, network communications, sleep characteristics, interaction measures between individuals and across channels, and self-reported data about relationship quality, negative and positive interactions, and mood.

4. The method of claim 3 wherein pronoun use, negative emotion words, swearing, certainty words in the speech content are evaluated.

5. The method of claim 3 wherein sleep length or quality is quantified.

6. The method of claim 2 wherein content of text messages and emails, time spent on the internet, number or length of texts and phone calls in the network communications are measured.

7. The method of claim 1 wherein data is stored separately in a peripheral device or integrated into a single platform.

8. The method of claim 7 wherein the peripheral device is a wearable sensor, cell phone, or audio storage device.

9. The method of claim 7 wherein the single platform is a mobile device or IoT platform.

10. The method of claim 1 further comprising computing signal-derived representations of the data streams.

11. The method of claim 10 wherein the signal-derived representations are computed by knowledge-based feature design and/or data-driven clustering.

12. The method of claim 10 wherein the signal-derived representations are used as a foundation for machine learning, data mining, and statistical algorithms that are used to determine what factors, or combination of factors, predict a variety of relationship dimensions, such as conflict, relationship quality, or positive interactions

13. The method of claim 1 wherein individualized models increase classification accuracy, since patterns of interaction may be specific to individuals, couples, or groups of individuals.

14. The method of claim 1 where active and semi-supervised learning are applied to increase predictive power as people continue to use a system implementing the method.

15. The method of claim 1 wherein the relationship functioning includes indices selected from the group consisting of a ratio of positive to negative interactions, number of conflict episodes, an amount of time two users spent together, an amount of quality time two users spent together, amount of physical contact, exercise, time spent outside, sleep quality and length, and coregulation or linkage across these measures.

16. The method of claim 15 wherein further comprising suggesting goals for these indices and allows users to customize their goals.

17. The method of claim 1 wherein feedback is provided as ongoing tallies and/or graphs viewable on the smart device.

18. The method of claim 1 further comprising creating daily, weekly, monthly, and yearly reports of relationship functioning.

19. The method of claim 1 further comprising allowing users to view, track, and monitor each of these data streams and their progress on their goals via customizable dashboards.

20. The method of claim 1 further comprising analyzing each data stream to provide a user with covariation of user's mood, relationship functioning, and various relationship-relevant events.

21. The method of claim 1 wherein user can create personalized networks and specify relationship types for each person in their network.

22. The method of claim 1 wherein users set person-specific privacy settings and customize personal data that can be accessed by others in their networks.

23. A system implements the method of any of claims 1-22, the system including:
a plurality of mobile smart devices operated by a plurality of users.

24. The system of claim 23 further comprising a plurality of sensors worn by the plurality of sensors.

25. The system of claim 23 wherein the mobile smart devices include a microprocessor and non-volatile memory on which instructions for implementing the method are stored.
